(19) United States
(12) Patent Application Publication
(10) Pub. No.: US 2009/0140997 A1
(43) Pub. Date: Jun. 4, 2009

(54) TERMINAL AND METHOD FOR PERFORMING FUCTION THEREIN

(75) Inventors: Seok Hyun Jeong, Seoul (KR); Jung Yeob Oh, Seongnam-si (KR); II Geun Bok, Seoul (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/324,111

(22) Filed: Nov. 26, 2008

(30) Foreign Application Priority Data
Dec. 4, 2007 (KR) 10-2007-0124690

(51) Int. Cl. G06F 3/041

(52) U.S. Cl. 345/173

(57) ABSTRACT

A terminal and a method for performing a function therein are provided. The method for performing a function in a terminal includes detecting touches in a first area and a second area of a touch screen in a specific mode, and performing a function corresponding to the first area with respect to an item corresponding to the second area.

### CROSS REFERENCE TO RELATED APPLICATION

This application claims priority from and the benefit of Korean Patent Application No. 10-2007-0124690, filed on Dec. 4, 2007, which is hereby incorporated by reference for all purposes as if fully set forth herein.

### BACKGROUND OF THE INVENTION

1. Field of the Invention

The present invention relates to a terminal and a method for performing a function therein, and more particularly, to a terminal and a method for performing a function therein in which a user may directly perform a specific function with respect to a specific item or a plurality of items when simultaneously selecting a specific function and items in a terminal.

2. Discussion of the Background

Nowadays, a terminal may perform a variety of functions according to user demand and store a large amount of information.

In a terminal having a touch screen, a user may select a plurality of items to perform a specific function, for example, ‘Delete,’ ‘Move,’ and ‘Copy’. In order to perform these functions, a user may convert the terminal to a multiple-selection mode and touch specific areas on the touch screen, for example, small check boxes for multiple-selection.

That is, a conversion to a multiple-selection mode may be additionally required, and a user may need to touch small check boxes, which may cause inconvenience. This may be particularly inconvenient in a terminal having a constant voltage type touch screen operated only by finger touches.

Further, in order to perform a function with respect to a specific item, a user may need to select the specific item and then touch an option or function button. By selecting a desired function among the displayed functions, a user may perform the desired function with respect to the selected item.

However, in this method, since a user may select an item by changing a screen focus and then select a function by again changing the screen focus, a terminal may not be suitable for a one-click touch screen.

### SUMMARY OF THE INVENTION

The present invention provides a terminal and a method for performing a function therein in which a user may select an item and a function by multiple-touching to easily perform the selected function for the selected item.

The present invention also provides a terminal and a method for performing a function therein in which a plurality of items may be easily selected.

The present invention also provides a terminal and a method for performing a function therein that may provide instantaneous and simple interaction by combining touches in an item area and a function area.

Additional features of the invention will be set forth in the description which follows, and in part will be apparent from the description, or may be learned by practice of the invention.

The present invention discloses a method for performing a function in a terminal including detecting touches in a first area and a second area of a touch screen in a specific mode, and performing a function corresponding to the first area with respect to an item corresponding to the second area.

The present invention also discloses a method for performing a function in a terminal including displaying a list including at least one received message and displaying at least one function on a touch screen in a received message display mode, detecting a touch of a specific function among the displayed functions and a touch of a specific message among the displayed list of received messages, and performing the specific function for the specific message.

The present invention also discloses a method for performing a function in a terminal including displaying at least one image and displaying at least one function on a touch screen in an image album mode, detecting a touch of a specific function among the displayed functions and a touch of a specific image among the displayed images, and performing the specific function for the specific image.

The present invention also discloses a terminal including a touch screen, a touch sensor to detect a touch on the touch screen, and a controller to perform a function corresponding to a first area with respect to an item corresponding to a second area when touches are detected on the first area and the second area, respectively.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a mobile terminal for performing a function according to an exemplary embodiment of the present invention.

FIG. 2 is a flow chart showing a method for performing a function in a mobile terminal according to another exemplary embodiment of the present invention.

FIG. 3A and FIG. 3B show screens of a mobile terminal in which a function is performed using the method of FIG. 2.

FIG. 4 is a flow chart showing a method for performing a function in a mobile terminal according to another exemplary embodiment of the present invention.

FIG. 5A, FIG. 5B, and FIG. 5C show examples of a screen of a mobile terminal in which a function is performed using the method of FIG. 4.

FIG. 6 is a flow chart showing a method for performing a function in a mobile terminal according to another exemplary embodiment of the present invention.

FIG. 7A, FIG. 7B, and FIG. 7C show examples of a screen of a mobile terminal in which a function is performed using the method of FIG. 6.

FIG. 8 is a flow chart showing a method for performing a function in a mobile terminal according to another exemplary embodiment of the present invention.

FIG. 9A, FIG. 9B, and FIG. 9C show screens of a mobile terminal in which a function is performed using the method of FIG. 8.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

Hereinafter, a ‘touch’ refers to a motion in which a user contacts a specific area on a touch screen with a finger or a stylus. A ‘release’ refers to a motion in which a user withdraws the contacting finger or stylus from the touch screen.

Hereinafter, a mobile terminal is exemplified for the convenience of description of exemplary embodiments of the present invention, but the present invention is not limited thereto. Exemplary embodiments of the present invention may be applied to all types of information communication devices and multimedia devices, such as a mobile terminal, mobile phone, wired/wireless phone, portable multimedia player (PMP), personal digital assistant (PDA), smart phone and MP3 player, and their applications. Further, the device may have a short distance wireless communication module.

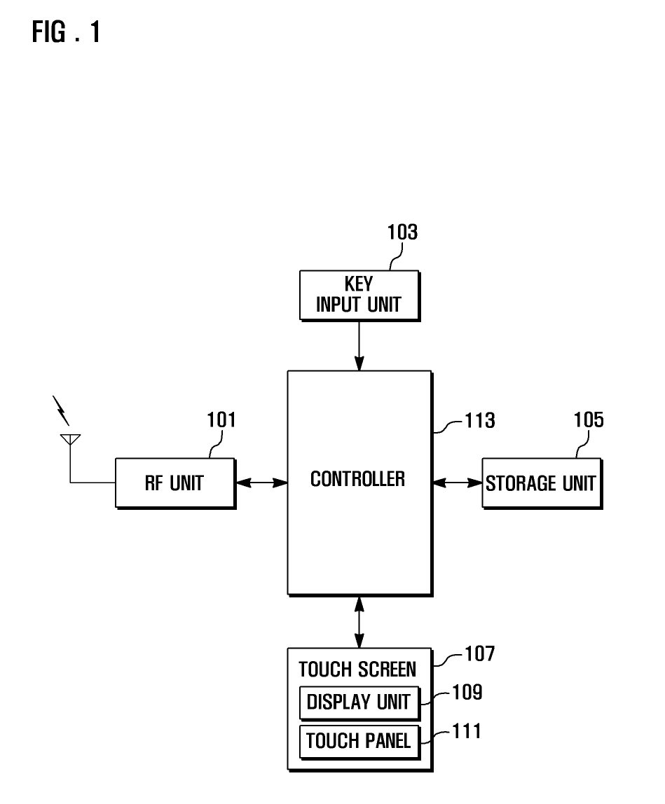

FIG. 1 is a block diagram showing a mobile terminal for performing a function according to an exemplary embodiment of the present invention.

Referring to FIG. 1, the mobile terminal includes an RF unit 101, a key input unit 103, a storage unit 105, a touch screen 107, and a controller 113.

The RF unit 101 performs a wireless communication function in a mobile terminal. The RF unit 101 includes an RF transmitter to amplify a transmission signal and up-convert a frequency thereof, and an RF receiver to low noise amplify a received signal and down-convert a frequency thereof. The RF unit 101 transmits and receives messages according to the present exemplary embodiment. Here, the message may be a short message service (SMS) message, a multimedia message service (MMS) message, or an enhanced message service (EMS) message. The message may be transmitted with an attachment, such as an image file.

Although, in the present exemplary embodiment, the mobile terminal includes the RF unit 101, the RF unit 101 may be omitted in other exemplary embodiments. Instead, the mobile terminal may include a short distance wireless communication module for the communication of information between mobile terminals, such as a Bluetooth® module.

The key input unit 103 receives an operational signal from a user to control operations of the mobile terminal. The user inputs information to enter a specific mode and a corresponding item through the key input unit 103. The specific mode may be, for example, a message creating mode, an image album mode, or a received message display mode. An item corresponding to the specific mode may be, for example, a message composition in the message creating mode, a received message in the received message display mode, and an image file in the image album mode.

The storage unit 105 stores programs and information for operations of the mobile terminal. The storage unit 105 stores various items corresponding to a specific mode and corresponding functions according to the present exemplary embodiment. If an item is a received message, corresponding functions in a received message display mode may include ‘Create new message’ and ‘Delete.’ If an item is an image file, corresponding functions in an image album mode may include ‘Send image,’ ‘Copy,’ ‘Move,’ and ‘Delete’.

The touch screen 107 may include a display unit 109 and a touch panel 111. The touch screen 107 may be used as an input unit, and the display unit 109 displays a state of the mobile terminal. The display unit 109 may be embodied as an LCD, in which case the display unit 109 may include an LCD controller, a memory to store display data, and an LCD element. The touch panel 111 is installed on a surface of the display unit 109, and includes a touch sensor and a signal converting unit. If a touch is generated on the touch panel 111, the touch sensor senses the touch by detecting a change in physical values, for example, resistance or electrostatic capacitance, when the touch occurs. The signal converting unit converts the change in physical values into a touch signal.

The touch screen 107 displays various information about states and operations of the mobile terminal. The touch screen 107 may display items corresponding to a specific mode as a list and displays corresponding functions. For example, in a received message display mode, the touch screen 107 displays received message items as a list and displays corresponding ‘Create new message’ and ‘Delete’ functions.

The controller 113 controls the overall operations of the mobile terminal. When an item list and corresponding functions in a specific mode are displayed on the touch screen 107, the controller 113 determines whether a specific item of the list and a specific function are selected. That is, the controller 113 detects touches at the display locations of the specific function and the specific item. When the controller 113 detects that a specific function is touched, then detects that a specific item is touched, upon release of the touches the controller 113 controls the terminal to perform the specific function for the specific item. Alternatively, when the controller 113 detects that a specific item is touched, then detects that a specific function is touched, the controller 113 controls the terminal to perform the specific function for the specific item upon the release of at least one of the touches.

The user may select a plurality of items and select a specific function to perform the specific function for the plurality of selected items. For example, the user may select a plurality of items and select a desired one of ‘Delete,’ ‘Edit,’ ‘Lock,’ or ‘Unlock’ functions, and the controller 113 performs the selected function for the selected items. Since the function may be performed while an item list is displayed on a screen, the function may be easily performed for the plurality of selected items.

If creation of a message is required, a create message function may be selected among the displayed functions, and the controller 113 receives signals informing of the selection of the specific item and function, and displays a message creation screen. The user then selects a displayed function for the selected item. For example, if the displayed functions include ‘Reply’ and ‘Send object’, the controller 113 performs the selected one of the ‘Reply’ and ‘Send object’ functions for the selected item.

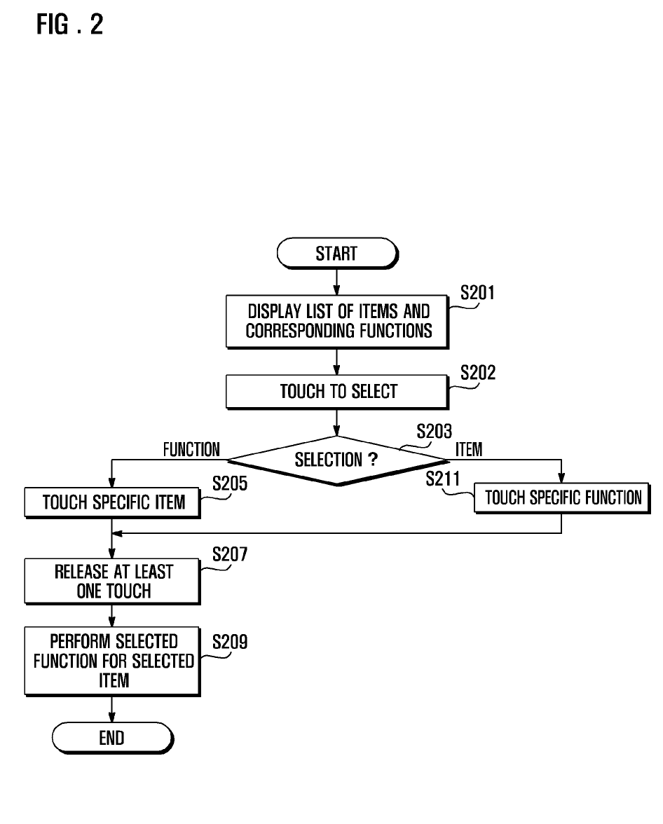

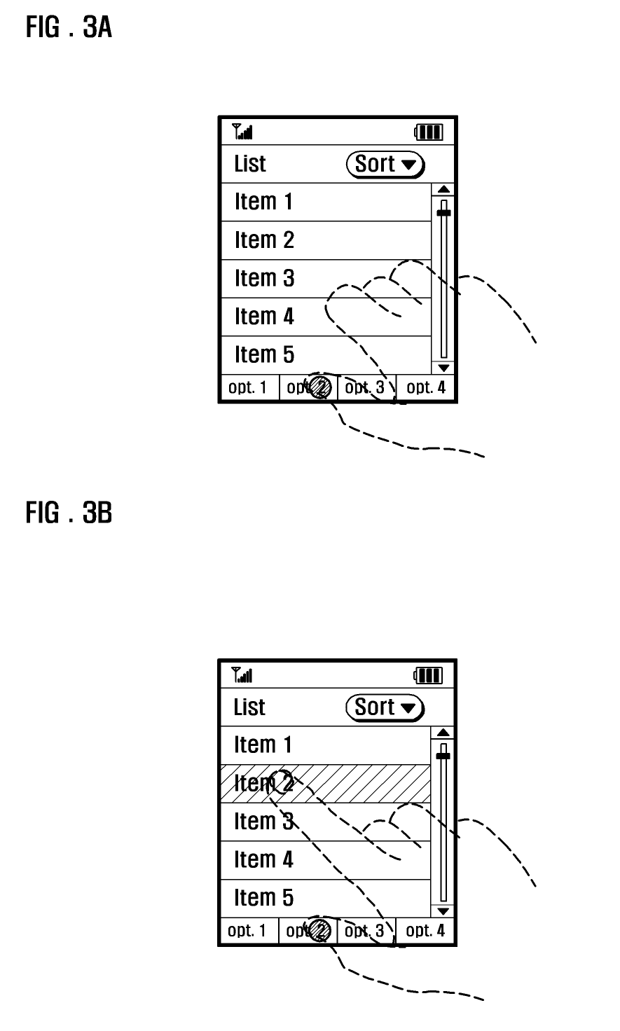

FIG. 2 is a flow chart showing a method for performing a function in a mobile terminal according to another exemplary embodiment of the present invention, and FIG. 3A and FIG. 3B show screens of a terminal in which a function is performed using the method of FIG. 2.

Referring to FIG. 2, the controller 113 controls the display unit 109 to display an item list and corresponding functions on the touch screen 107 in a specific mode (S201). That is, items corresponding to the specific mode selected by a user are displayed as a list, and corresponding functions are displayed on the touch screen 107.

When the controller 113 detects a selection by a user by detecting a touch on the touch screen 107 (S202), the controller 113 determines whether the user touches and selects a specific item among the list displayed on the touch screen 107 or touches and selects a specific function among the functions displayed on the touch screen 107 (S203).

If the controller 113 determines that a specific function is touched and selected at step S203, the controller 113 then determines a specific item that is touched (S205). For example, when a user touches a specific function Opt2, as shown in FIG. 3A, the user may simultaneously touch a specific item Item2, as shown in FIG. 3B.

If the controller 113 determines that a specific item is touched and selected at step S203, the controller 113 then determines a specific function that is touched (S211). For example, while a specific item is touched, the user may touch a specific function. When the controller 113 determines that at least one of the touches at step S205 and step S211 are released (S207), the controller 113 performs the selected function for the selected item (S209).

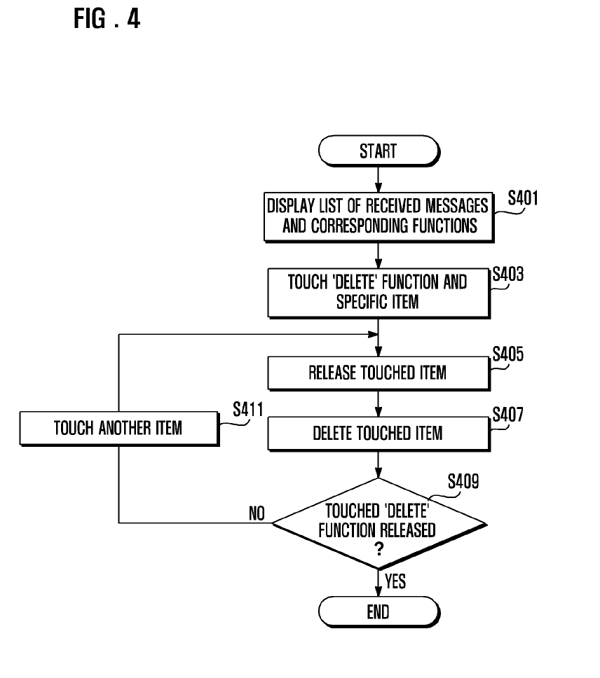

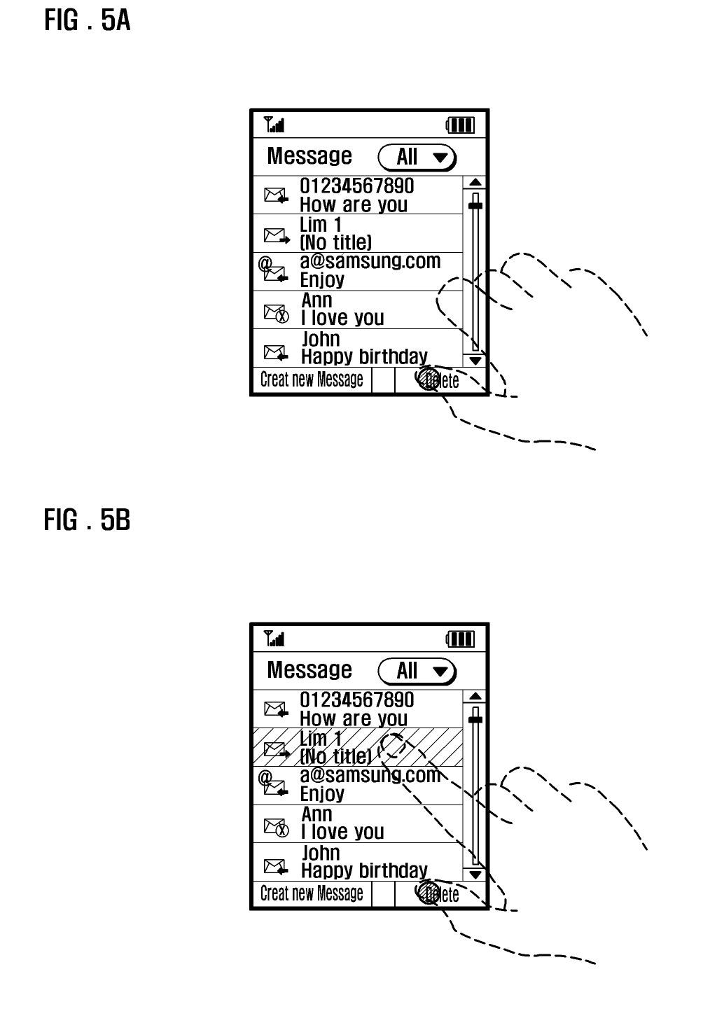

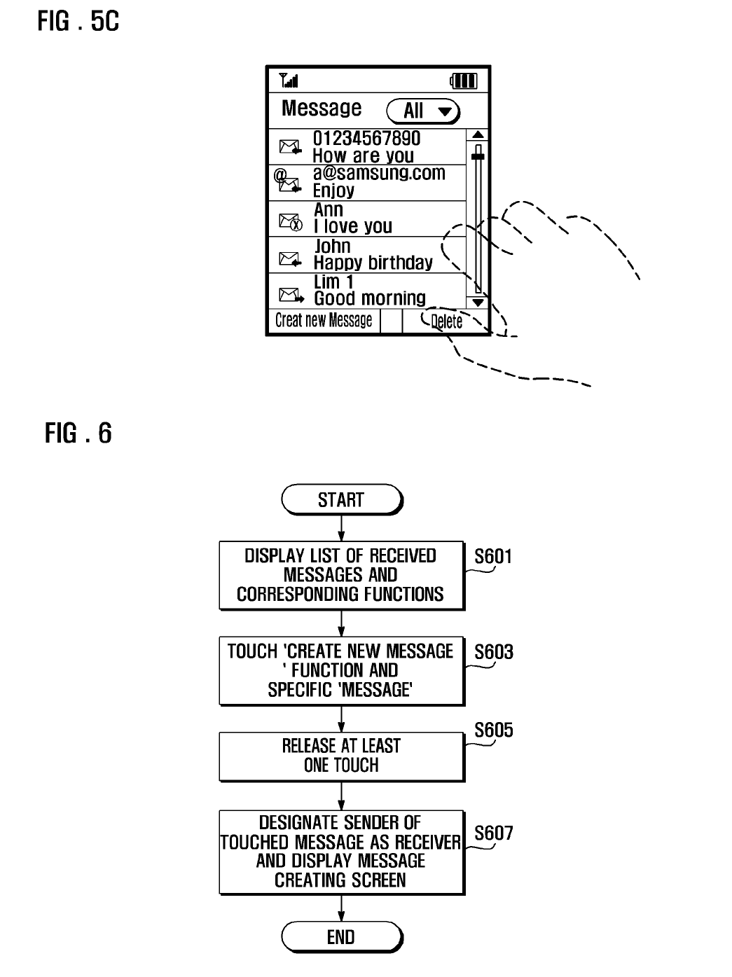

FIG. 4 is a flow chart showing a method for performing a function in a mobile terminal according to another exemplary embodiment of the present invention, and FIG. 5A, FIG. 5B, and FIG. 5C show examples of a screen of a terminal in which a function is performed using the method of FIG. 4.

Referring to FIG. 4, if a user selects a received message display mode, the controller 113 controls the display unit 109 to display a list of received messages and corresponding functions on the touch screen 107 (S401). Functions corresponding to the received message display mode, for example, ‘Create new message’ and ‘Delete,’ may be displayed on the touch screen 107.

Then the controller 113 determines that the ‘Delete’ function is touched and a specific item of the list is touched (S403). For example, if a user touches the ‘Delete’ function, as shown in FIG. 5A, the user may simultaneously touch the second received message, as shown in FIG. 5B. In this exemplary embodiment, an item is touched while a function is being touched, but the present invention is not limited thereto. In another exemplary embodiment, a function may be touched while an item is being touched.

When the controller 113 determines that the item touch is released (S405), the controller 113 deletes the touched item (S407). For example, if the user releases the item touch, as shown in FIG. 5B, the controller 113 deletes the item that was touched, as shown in FIG. 5C.

Then, the controller 113 determines whether the function touch is released (S409). If the function touch is released, the controller 113 terminates the corresponding function.

If the controller 113 determines that the function touch is maintained at step S409, the controller 113 determines if another specific item is touched (S411). That is, a user may select any other received message to be deleted while touching the ‘Delete’ function.

The process then returns to step S405 and the controller 113 determines that the item touch is released, then deletes the other touched item (S407). In this respect, a user may continuously delete a plurality of messages by touching and releasing the messages while touching the ‘Delete’ function.

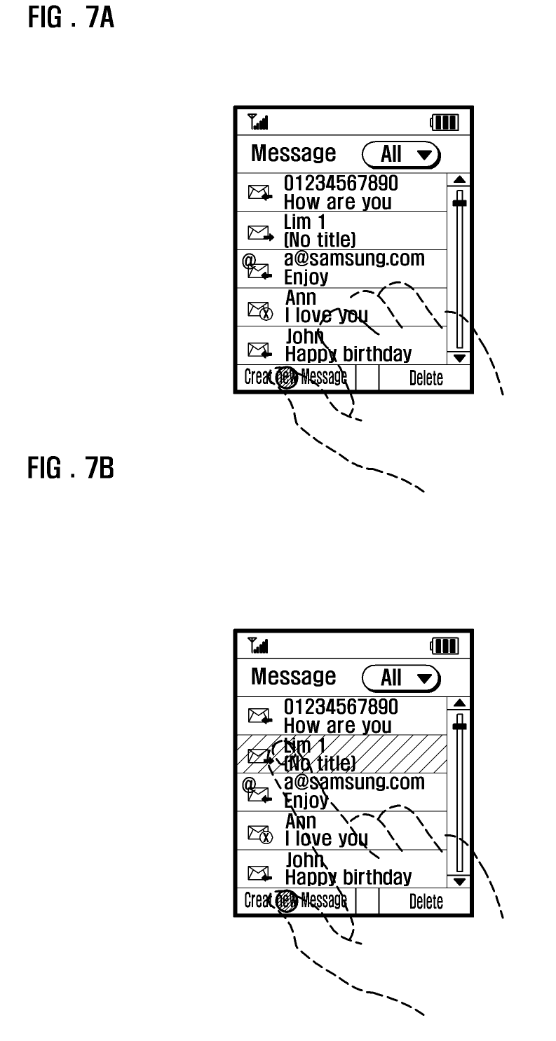

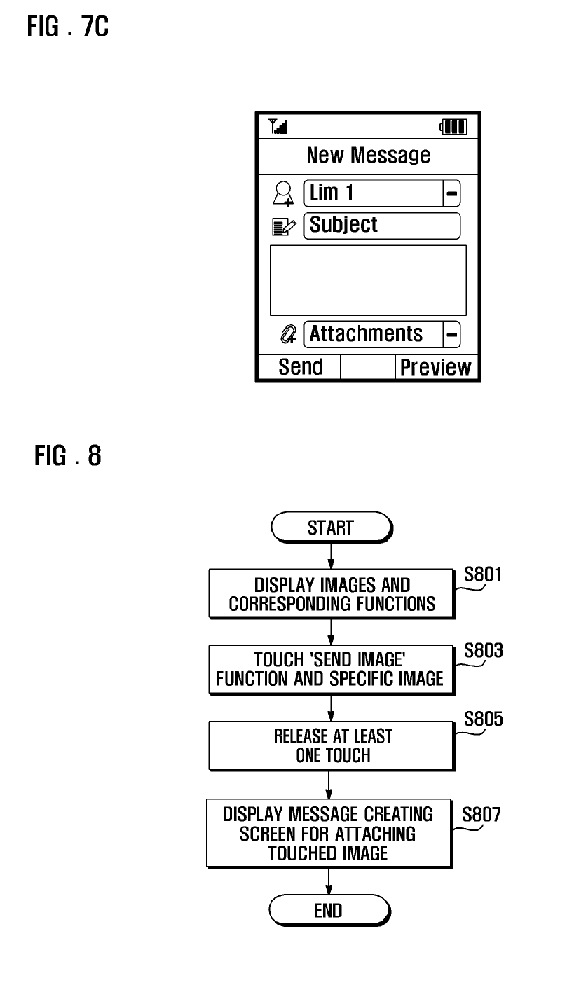

FIG. 6 is a flow chart showing a method for performing a function of a mobile terminal according to another exemplary embodiment of the present invention, and FIG. 7A, FIG. 7B, and FIG. 7C show examples of a screen in which a function is performed using the method of FIG. 6.

Referring to FIG. 6, the controller 113 controls the display unit 109 to display a list of received messages and corresponding functions on the touch screen 107 (S601). For example, the controller 113 controls the display unit 109 to display the received messages and the functions ‘Create new message’ and ‘Delete’ on the touch screen 107.

The controller 113 then determines that the ‘Create new message’ function is touched and then a specific received message of the list is touched (S603). For example, while a user touches the ‘Create new message’ function, as shown in FIG. 7A, the user may also touch the second received message, as shown in FIG. 7B. Alternatively, a specific function may be touched while a specific received message is touched.

When the controller 113 determines that at least one of the touches of the function and the received message are released (S605), the controller 113 displays a message creating screen on the touch screen 107 including contact details (for example, a phone number) of the sender of the touched received message (S607). For example, in the state shown in FIG. 7B, if the user releases the touches, the controller 113 designates a sender of the selected message as a receiver and displays the message creating screen on the touch screen 107, as shown in FIG. 7C.

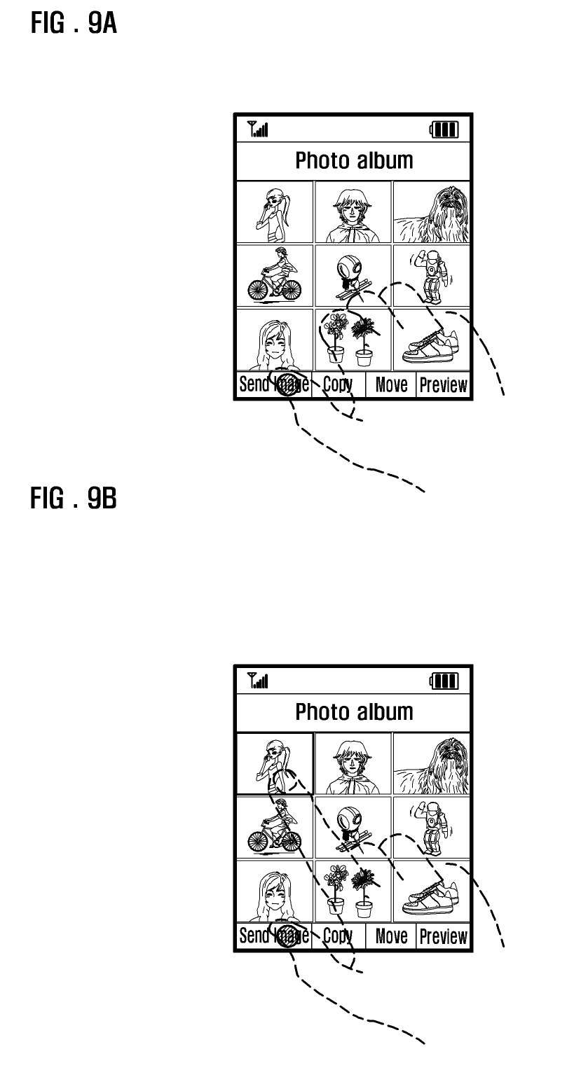

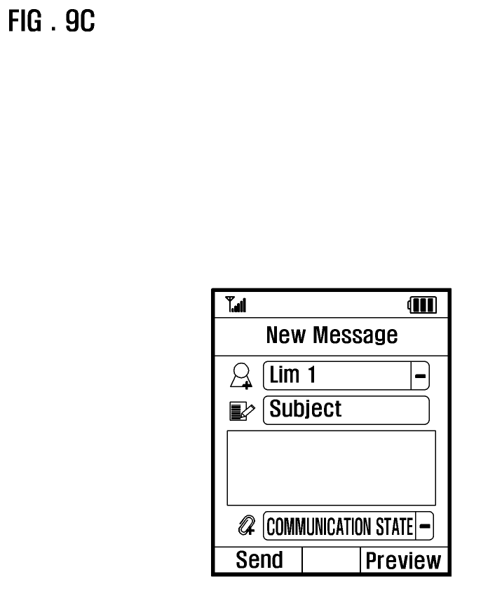

FIG. 8 is a flow chart showing a method for performing a function of a mobile terminal according to another exemplary embodiment of the present invention, and FIG. 9A, FIG. 9B, and FIG. 9C show screens in which a function is performed using the method of FIG. 8.

Referring to FIG. 8, if a user selects an image album mode, the controller 113 controls the display unit 109 to display images and corresponding functions on the touch screen 107 (S801). The controller 113 controls the display unit 109 to display images stored in the storage unit 105 and functions, for example, ‘Send image,’ ‘Copy,” Move,’ and ‘Preview’, on the touch screen 107.

The controller 113 then determines that the ‘Send image’ function is touched and then a specific image is touched (S803). For example, while the user touches the ‘Send image’ function, as shown in FIG. 9A, the user may also touch a specific image, as shown in FIG. 9B. Alternatively, a specific function may be touched while a specific image is touched.

When the controller 113 determines that the touches of the function and the image are released (S805), the controller 113 controls the display unit 109 to display a message creating screen to which the touched image is to be attached on the touch screen 107 (S807). For example, in the state shown in FIG. 9B, if the user releases at least one of the touches from the touch screen 107, the controller 113 controls the display unit 109 to display a message creating screen to which the selected image is to be attached on the touch screen 107, as shown in FIG. 9C.

In the present exemplary embodiment, one image file is selected, but the present invention is not limited thereto. In another exemplary embodiment, when a user touches the ‘Send image’ function and touches and releases a plurality of image files, a message creating screen to which the plurality of selected image files are to be attached may be displayed. Further, instead of selecting the ‘Send image’ function, a user may select any of the displayed functions in order to perform the corresponding function.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for performing a function in a terminal, comprising:
detecting touches in a first area and a second area of a touch screen in a specific mode; and
performing a function corresponding to the first area with respect to an item corresponding to the second area.

2. The method of claim 1, wherein detecting touches comprises:
displaying at least one item corresponding to the specific mode and at least one corresponding function; and
detecting a touch of a specific item among the displayed items and a touch of a specific function among the displayed functions.

3. The method of claim 2, wherein performing a function comprises:
detecting a release of at least one of the touches; and
executing the specific function with respect to the specific item when the specific function and the specific item were touched simultaneously prior to the release of at least one of the touches.

4. The method of claim 3, wherein executing the specific function with respect to the specific item comprises executing the touched specific function with respect to a plurality of touched items when the plurality of items are touched and released while the specific function is touched.

5. A method for performing a function in a terminal, comprising;
displaying a list including at least one received message and displaying at least one function on a touch screen in a received message display mode;
detecting a touch of a specific function among the displayed functions and a touch of a specific message among the displayed list of the at least one received message; and
performing the specific function for the specific message.

6. The method of claim 5, wherein performing the specific function comprises:
detecting a release of at least one of the touches; and
executing the specific function for the specific message when the specific function and the specific message were touched simultaneously prior to the release of at least one of the touches.

7. The method of claim 6, wherein the at least one function comprises a ‘Delete message’ function or a ‘Create new message’ function.

8. The method of claim 7, wherein executing the specific function comprises deleting the specific message when the ‘Delete message’ function and the specific message were touched simultaneously prior to the release of at least one of the touches.

9. The method of claim 7, wherein executing the specific function comprises deleting all touched messages when the messages are touched and released while the ‘Delete message’ function is touched.

10. The method of claim 7, wherein executing the specific function comprises:
designating a sender of the touched message as a receiver when the ‘Create new message’ function and the specific message are touched; and
displaying a message creating screen.

11. A method for performing a function in a terminal, comprising:
displaying at least one image and displaying at least one function on a touch screen in an image album mode;
detecting a touch of a specific function among the displayed functions and a touch of a specific image among the displayed images; and
performing the specific function for the specific image.

12. The method of claim 11, wherein performing the specific function comprises:
detecting a release of at least one of the touches; and
executing the specific function with respect to the specific image when the specific function and the specific image were touched simultaneously prior to the release of at least one of the touches.

13. The method of claim 12, wherein the at least one function comprises a ‘Send image’ function, a ‘Copy’ function, a ‘Move’ function, or a ‘Delete’ function.

14. The method of claim 13, wherein executing the specific function comprises displaying, a message creating screen to which the specific image is to be attached if the ‘Send image’ function and the specific image are touched simultaneously.

15. A terminal, comprising:
a touch screen;
a touch sensor to detect a touch on the touch screen; and
a controller to perform a function corresponding to a first area with respect to an item corresponding to a second area when touches are detected on the first area and the second area, respectively.

16. The terminal of claim 15, wherein the touch screen displays at least one item corresponding to a specific mode and at least one corresponding function, and the touch sensor detects a touch of a specific item among the displayed items and a touch of a specific function among the displayed functions.

17. The terminal of claim 16, wherein the controller performs the specific function with respect to the specific item when the specific function and the specific item are touched simultaneously and at least one of the touches is released.

18. The terminal of claim 17, wherein the controller performs the specific function for a plurality of items when the plurality of items are touched and released while the specific function is touched.
